(19) United States
(12) Patent Application Publication
(10) Pub. No.: US 2026/0183094 A1
(43) Pub. Date: Jul. 2, 2026

(54) CONTROL METHOD OF PERSONAL CARE APPARATUS, COMPUTING APPARATUS AND STORAGE MEDIUM

(71) Applicant: Shenzhen Soocas Technology Co., Ltd., Shenzhen (CN)

(72) Inventors: Yanqiang LI, Shenzhen (CN); Yingjun WANG, Shenzhen (CN); Zhikun YIN, Shenzhen (CN)

(73) Assignee: Shenzhen Soocas Technology Co., Ltd., Shenzhen (CN)

(21) Appl. No.: 19/428,397

(22) Filed: Dec. 22, 2025

Related U.S. Application Data
(63) Continuation of application No. PCT/CN2025/114883, filed on Aug. 15, 2025.

(30) Foreign Application Priority Data
Dec. 26, 2024 (CN) 2024119747208

(51) Int. Cl. A61C 17/22; A61C 17/34

(52) U.S. Cl. CPC A61C 17/221; A61C 17/3436

(57) ABSTRACT

Provided is a control method of a personal care apparatus. The personal care apparatus includes a cleaning part and a holding part, the holding part includes a driving unit, a control unit and a sensing unit accommodated in the holding part, and the sensing unit is electrically connected with the control unit to transmitted sensed brushing attitude information to the control unit; the control unit is configured to determine a target cleaning region based on the brushing attitude information, and determine a corresponding driving parameter according to the target cleaning region to generate a control signal; and the driving unit is configured to output an initial motion corresponding to the target cleaning region in response to one or more control signals sent by the control unit, and drive the cleaning part to execute a target motion corresponding to the target cleaning region.

### CROSS-REFERENCE TO RELATED APPLICATIONS

The application is a continuation of International Application No. PCT/CN2025/114883, filed on August 15, 2025, which claims priority of Chinese patent application No. 2024119747208, filed on December 26, 2024 and entitled “Control Method of Personal Care Apparatus, Computing Apparatus, Storage Medium, and Program Product”. The entire contents of the Chinese patent application are incorporated herein by reference.

### TECHNICAL FIELD

The present disclosure relates to the technical field of cleaning, in particular to a control method of a personal care apparatus, a computing apparatus, a storage medium, and a program product.

### BACKGROUND

An oral cavity has a complicated structure, including such regions as lateral surfaces and a chewing surface of teeth and slits between the teeth, and each region has different requirements for cleaning due to shape, position and space limitations. Although existing electric tooth brushes have a variety of motion cleaning forms, such as rotation, vibration and swing, control modes of the existing electric toothbrushes are fixed, and only a single form of cleaning can be fixedly output, so that a cleaning efficiency is influenced.

### SUMMARY

In view of this, the present disclosure provides a control method of a personal care apparatus. One or more embodiments of the present disclosure simultaneously relate to a computing apparatus, a computer-readable storage medium and a computer program to solve technical defects in the prior art.

According to a first aspect of the present disclosure, a control method of a personal care apparatus is provided.

The personal care apparatus includes:

a cleaning part; and

a holding part including a driving unit, a control unit and a sensing unit accommodated in the holding part, wherein,

the sensing unit is electrically connected with the control unit and transmits sensed brushing attitude information to the control unit;

the control unit is configured to determine a target cleaning region based on the brushing attitude information, and determine a corresponding driving parameter according to the target cleaning region to generate a control signal; and

the driving unit is coupled with the cleaning part and configured to output an initial motion corresponding to the target cleaning region in response to one or more control signals sent by the control unit, and drive the cleaning part to execute a target motion corresponding to the target cleaning region, wherein at least partial motion modes of the target motions corresponding to different cleaning regions are different.

In one embodiment of the present disclosure, at least partial motion modes of the initial motions corresponding to different cleaning regions are different.

In one embodiment of the present disclosure, the motion modes of the initial motions corresponding to different cleaning regions at least include one of the following differences: different motion paths, different motion frequencies, different reciprocating angles and different motion strokes.

In one embodiment of the present disclosure, the initial motion path includes, but is not limited to one or a combination of more of an axial motion and a circumferential motion.

In one embodiment of the present disclosure, the initial motion is a multi-mode motion, including but not limited to: x-y axis composite motions, circumferential-axial composite motions and two circumferential composite motions.

In one embodiment of the present disclosure, the cleaning part includes at least two cleaning units, and the target motion includes motions of the at least two cleaning units; and

the personal care apparatus further includes a transmission mechanism attached to the driving unit, the transmission mechanism is in transmission connection with the cleaning unit and is configured to convert the initial motion output by the driving unit to at least one cleaning unit and drive the at least two cleaning units to move in two different motion modes respectively.

In one embodiment of the present disclosure, the at least two cleaning units include a first cleaning unit and a second cleaning unit,

corresponding motions of the first cleaning unit in different cleaning regions have different motion modes; and/or,

corresponding motions of the second cleaning unit in different cleaning regions have different motion modes.

In one embodiment of the present disclosure, motion modes of the at least two cleaning units at least include one of the following differences: different motion paths, different motion frequencies, different reciprocating angles and different motion strokes.

In one embodiment of the present disclosure, the motion path includes, but is not limited to: a pivot path, a reciprocating rotation path, a knocking motion path, a reciprocating vibration path, a reciprocating sweeping path, a horizontal linear motion, a longitudinal linear motion and/or a pendulum motion.

In one embodiment of the present disclosure, the sensing unit includes an attitude sensor.

In one embodiment of the present disclosure, the sensing unit further includes a pressure sensor, and the sensing unit is further used to sense pressure information applied to the personal care apparatus and transmit the sensed pressure information to the control unit; and

the control unit is further used to determine the corresponding driving parameter according to the target cleaning region and the pressure information to generate the control signal.

In one embodiment of the present disclosure, the control unit determines the driving parameter based on the target cleaning region, wherein the driving parameter includes, but is not limited to: a rotation direction, a rotation angle, a rotation speed and/or a torque.

In one embodiment of the present disclosure, the initial motion is a periodic motion, and at least partial motion modes of the periodic motions corresponding to the different cleaning regions are different.

In one embodiment of the present disclosure, the periodic motion includes one or more motions with different modes, and the periodic motions corresponding to the different cleaning regions at least includes one of the following differences: different motion quantities included, different output sequences of motions with the same mode, and at least one different motion mode.

According to a second aspect of the present disclosure, a computing apparatus is provided, including:

a memory and a processor, wherein,

the memory is used to store a computer-executable instruction, the processor is used to execute the computer-executable instruction, and the computer-executable instruction, when being executed by the processor, implements the steps of the control method of the personal care apparatus mentioned above.

According to a third aspect of the present disclosure, a computer-readable storage medium storing a computer-executable instruction thereon is provided, wherein the computer-executable instruction, when being executed by a processor, implements the steps of the control method of the personal care apparatus mentioned above.

According to a fourth aspect of the present disclosure, a computer program product including a computer instruction is provided, wherein the computer program, when being executed by a processor, implements the steps of the control method of the personal care apparatus mentioned above.

### BRIEF DESCRIPTION OF THE DRAWINGS

FIG. 1 is a schematic structural diagram of a personal care apparatus provided by one embodiment of the present disclosure;

FIG. 2 is a flowchart of a control method of a personal care apparatus provided by one embodiment of the present disclosure; and

FIG. 3 is a structural block diagram of a computing apparatus provided by one embodiment of the present disclosure.

### DETAILED DESCRIPTION OF THE EMBODIMENTS

Numerous specific details are set forth in the following description to sufficient understand the present disclosure. However, the present disclosure can be implemented in many other ways different from those described herein, and those skilled in the art can make similar promotion without violating the connotation of the present disclosure, so the present disclosure is not limited by the specific embodiments disclosed below.

The terms used in one or more embodiments of the present disclosure are for the purpose of describing specific embodiments only and are not intended to limit one or more embodiments of the present disclosure. The singular forms “a”, “the” and “this” used in one or more embodiments of the present disclosure and the appended claims are also intended to include the plural forms, unless the context clearly indicates otherwise. It should be further understood that the term “and/or” used in one or more embodiments of the present disclosure refers to any combination and all possible combinations of one or more of the associated listed items.

It should be understood that although the terms such as “first” “second” and the like may be used to describe various information in one or more embodiments of the present disclosure, the information should not be limited to these terms. These terms are merely used to distinguish between information of the same type. For example, without departing from the scope of one or more embodiments of the present disclosure, first may also be referred to as second, and similarly, second may also be referred to as first. Depending on the context, for example, the word “if” used herein may be interpreted as “while” or “when,” or “in response to determination”.

In addition, it should be noted that user information (including but not limited to user device information, user personal information, etc.) and data (including but not limited to data for analysis, stored data, displayed data, etc.) involved in one or more embodiments of the present disclosure are all information and data authorized by users or fully authorized by all parties, and collection, use and processing of relevant data need to comply with relevant laws, regulations and standards of relevant countries and regions, and corresponding operation portals are provided for the users to authorize or reject.

In the present disclosure, a control method of a personal care apparatus is provided, and meanwhile, the present disclosure relates to a computing apparatus, a computer-readable storage medium and a computer program product, which are described in detail in the following embodiments one by one.

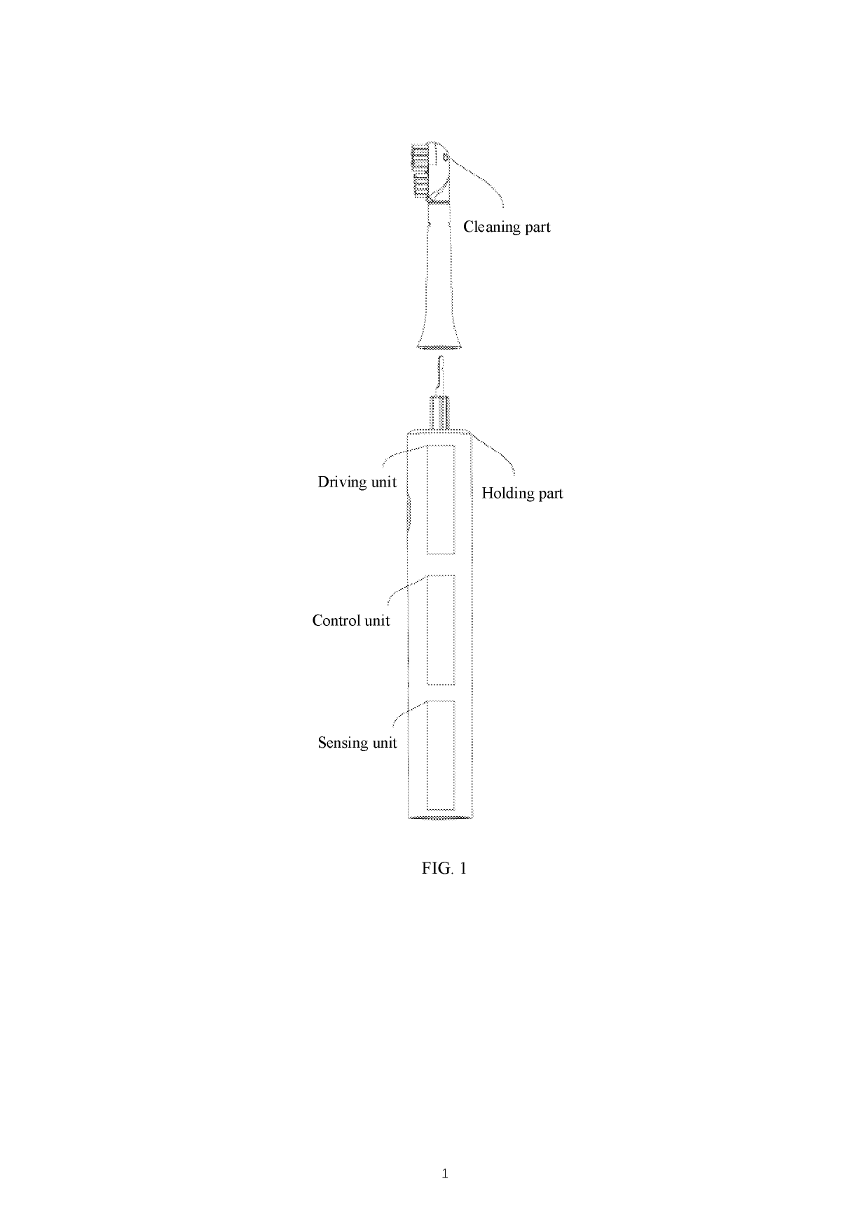

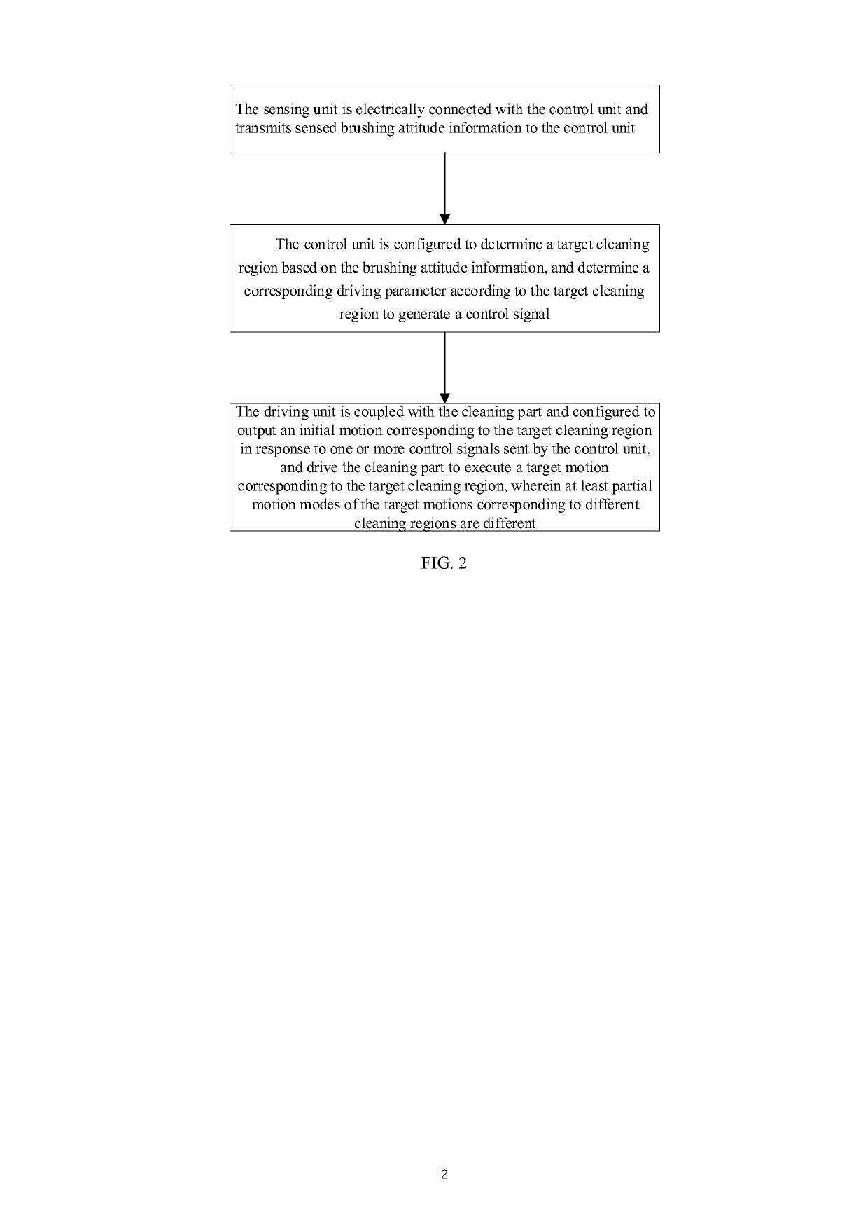

Referring to FIG. 1 and FIG. 2, according to a first aspect of the present disclosure, a control method of a personal care apparatus is provided. The personal care apparatus includes a cleaning part; and a holding part including a driving unit, a control unit and a sensing unit accommodated in the holding part, wherein, the sensing unit is electrically connected with the control unit and transmits sensed brushing attitude information to the control unit; the control unit is configured to determine a target cleaning region based on the brushing attitude information, and determine a corresponding driving parameter according to the target cleaning region to generate a control signal; and the driving unit is coupled with the cleaning part and configured to output an initial motion corresponding to the target cleaning region in response to one or more control signals sent by the control unit, and drive the cleaning part to execute a target motion corresponding to the target cleaning region, wherein at least partial motion modes of the target motions corresponding to different cleaning regions are different.

In the embodiment, the personal care apparatus may be an electric toothbrush, a massager, a face cleaner or other personal care apparatuses well known to those skilled in the art. The control method of the personal care apparatus in the embodiment will be described below by taking the personal care apparatus being an electric toothbrush as an example.

Referring to FIG. 1, the personal care apparatus of the present disclosure includes a cleaning part and a holding part, wherein the cleaning part is provided with bristles which are in direct contact with a tooth surface of a user for removing food residues and dental plaque on the tooth surface of the user. The holding part is suitable for a part held by the user, and the driving unit, the control unit and the sensing unit are integrated inside the holding part. The sensing unit may be an accelerometer, a gyroscope or other types of sensors, and is used to detect brushing posture information of the user when brushing teeth. The brushing attitude information may include a brushing angle, a brushing pressure, and the like. The sensing unit may monitor a pressure applied by the user when brushing teeth, a time duration for brushing teeth, and a situation that whether all tooth surfaces are covered, and the like. Not only can the target cleaning region being cleaned be determined, but also it is helpful to ensure that the user will not apply an excessive force to cause gingiva damage, and ensure that each cleaning will last for enough time.

The control unit is electrically connected with the sensing unit and used to receive data from the sensing unit, further analyzing a brushing attitude of the current user, and determining a target cleaning region that the user is currently cleaning, such as an incisor region, a molar region and the like. The driving unit selects a corresponding driving parameter to generate a corresponding control signal based on the determined target cleaning region. In response to the control signal received from the control unit, the driving unit generates a predetermined pattern of motion, such as one or a combination of vibration, rotation or pulse action, or adjusts a motion parameter, such as increasing amplitude and adjusting jump angle, so as to drive the cleaning part to execute effective cleaning for the target cleaning region. In addition, an intelligent identification model is further embedded in the control unit. The model can identify a brushing habit of the user and optimize a cleaning strategy according to the change of time. For example, when it is found that the user often misses a cleaning region, the control unit may adjust a prompt or change the motion mode to guide the user to clean correctly.

Because the structures of different cleaning regions of teeth are different, and different cleaning regions need to correspond to different cleaning modes, at least partial motion modes of the target motions corresponding to different cleaning regions are different. For example, a horizontal vibration motion may be used in the incisor region, and a circular motion may be used in the molar region. Choosing different cleaning modes based on different cleaning regions may provide personalized cleaning experience according to actual use of the user, which can remove dental plaque and other stains more thoroughly, reduce risks of tooth decay and periodontal disease, and improve cleaning efficiency. In addition, because oral structures of different users are different, customizing the most suitable cleaning solution based on individual differences can make each tooth cleaning more suitable for individual needs.

In the embodiment, the personal care apparatus has Bluetooth or other wireless communication capabilities, which may allow the personal care apparatus to be paired with smartphone applications, so that not only can brushing data be tracked and analyzed, but also personalized suggestions and feedback can be provided to the user, and even an oral health condition can be monitored and shared with a dentist for remote monitoring.

According to the control method of the personal care apparatus provided by the present disclosure, target cleaning regions are determined based on brushing attitude information, corresponding target motions are determined according to the target cleaning regions, and the target motions corresponding to different cleaning regions at least partially have different motion modes, so that cleaning in different regions is realized, which obviously improves the cleaning efficiency and cleaning effect, and reduces a risk of damage to sensitive tissues such as gums. This personalized and smart cleaning method not only enhances user experience, but also provides targeted oral care and promotes users to develop good brushing habits.

In one embodiment of the present disclosure, at least partial motion modes of the initial motions corresponding to different cleaning regions are different.

At least partial motion modes of the initial motions corresponding to different cleaning regions are different, such that at least partial motion modes of the corresponding target motions are different. In other words, the personal care apparatus can adjust a cleaning action according to characteristics of different tooth regions. This differentiated cleaning mode can ensure that each region can be cleaned most effectively. The following is an example based on different tooth regions and corresponding motion modes thereof.

For example, for an anterior tooth region (incisor region), because a surface of the anterior tooth is relatively flat and located in front of the oral cavity, the anterior tooth is suitable for cleaning with gentle and wide coverage. Lateral vibration or slight circular motion is selected to clean the anterior tooth region (incisor region) to ensure that the surface is smooth and free of stains.

For a posterior tooth region (molar region), because the posterior tooth has a complicated occlusal surface and more grooves, a more powerful cleaning action is needed to remove embedded food residues and dental plaque. Here, an occlusal surface is automatically adjusted to a polishing motion to gently but effectively clean these complicated structures and ensure that food residues and dental plaque are completely removed.

For sides of teeth and a vicinity of a gingiva line, because these regions are easy to accumulate dental plaque and close to the gingiva, it is necessary to clean these regions in a gentle way, so as to not only ensure a cleaning effect but also avoid irritating the gingiva. A vertical vibration action up and down or a small-amplitude pulse action is selected for cleaning. Meanwhile, composite cleaning is adopted for crevices on the sides of teeth, which may be adjusted into a motion of swinging from left to right combined with a reciprocating rotation, and a power may also be improved to adaptively adjust the cleaning mode to ensure that every corner can get proper attention without hurting the gingiva.

For regions between the teeth, it is difficult to clean the regions between teeth, so it is usually necessary to use a water flow or an air flow generated by high-frequency vibration to help clear hard-to-reach regions such as crevices. A high-frequency vibration or ultrasonic pulse action is selected for cleaning, so as to ensure that even the smallest crevices can be kept clean.

For regions of inner tooth surfaces, due to small contact area and irregular shape, it is necessary to flexibly adjust an angle of a brush head to ensure the cleaning effect. A best cleaning effect can be achieved by combining adaptive angle adjustment with moderate circular motion.

In this way, the personal care apparatus may be provide the user with a more personalized and efficient cleaning experience, and automatically switch the motion modes based on different cleaning regions, which not only improves the cleaning efficiency, but also takes care of comfort and safety of the user.

In one embodiment of the present disclosure, the motion modes of the initial motions corresponding to different cleaning regions at least include one of the following differences: different motion paths, different motion frequencies, different reciprocating angles and different motion strokes.

The different motion modes of the initial motions make at least partial motion modes of the corresponding target motions be different. Specifically, the personal care apparatus may select the corresponding motion modes of different initial motions thereof based on different cleaning regions, which are illustrated below.

For the different motion paths:

the anterior tooth region may adopt horizontal or slightly inclined linear motion path, while the posterior tooth region may use more circular motion or more complicated curved path to better cover the occlusal surface and the grooves.

For the different motion frequencies:

for a sensitive region, such as the vicinity of the gingiva line, a low-frequency motion may be used, thus reducing irritation to the gingiva. For a non-sensitive region, such as the molar region, high-frequency rapid vibration or rotation may be adopted to more thoroughly remove the food residues and the dental plaque.

For the different reciprocating angles:

outer tooth surfaces are relatively flat, and only a small angle change is needed. Shapes of the inner tooth surfaces are irregular and the contact area is small, which requires greater angle adjustment to ensure that the every corner can be cleaned by the personal care apparatus.

For the different motion strokes:

the space between teeth is relatively narrow, so a short but frequent stroke may be adopted, and a water flow or an air flow generated by high-frequency vibration may be used to assist cleaning. For a large area of tooth surface, such as the anterior tooth region, a longer stroke may be used to ensure that the whole surface is evenly cleaned.

In one embodiment of the present disclosure, the initial motion path includes, but is not limited to one or a combination of more of an axial motion and a circumferential motion.

Specifically, the axial motion is a reciprocating or continuous linear motion of the brush head along an axial direction of the brush head, which may be applied to cleaning of slits between teeth and polishing of tooth the tooth surfaces. High-frequency axial vibration may help to remove the food residues embedded in teeth, so as to achieve an effect similar to flossing, while slow axial motion may be used to gently polish the tooth surfaces and reduce roughness of the tooth surfaces. The circumferential motion is a rotation or circular motion of the brush head around the axis of the brush head. A circumferential motion with larger intensity may be used to clean the occlusal surface, which is helpful to thoroughly remove the food residues and the dental plaque on the complicated occlusal surface of the posterior teeth. For large and flat surfaces such as the anterior teeth, the circumferential motion may provide wide cleaning coverage to ensure that every corner is fully cleaned. In addition, in the embodiment, the axial motion and the circumferential motion may also be combined to form a composite cleaning action. For example, the circumferential rotation motion with a certain frequency may be performed first, and then the axial vibration can be performed. This composite cleaning action may clean multiple surfaces of teeth at the same time and improve the cleaning efficiency. According to the oral structure and personal habits of the user, the personal care apparatus can dynamically adjust a proportion of the axial motion and the circumferential motion to provide the most suitable cleaning solution for specific regions.

By flexibly combining the axial motion and the circumferential motion, the personal care apparatus may provide more diversified cleaning methods according to the characteristics of different cleaning regions. For example, when cleaning the anterior teeth, the personal care apparatus may use a large circumferential motion to cover the whole tooth surface, while when treating the complicated occlusal surface of the posterior teeth, axial vibration may be to clean the groove deeply. For sensitive regions in the vicinity of the gingiva line, the personal care apparatus may reduce an intensity of motion and optimize a ratio of the two motions to ensure safe and effective cleaning.

In one embodiment of the present disclosure, the initial motion is a multi-mode motion, including but not limited to: x-y axis composite motions, circumferential-axial composite motions and two circumferential composite motions.

The x-y axis composite motions are that the brush head moves simultaneously or alternately in two mutually perpendicular directions, forming a complicated two-dimensional motion path. For the anterior tooth region (incisor region), because the surface of the anterior tooth region is relatively flat and located in front of the oral cavity, the personal care apparatus may start the x-y axis composite motions as the initial motion mode to ensure that every corner of the tooth surface can be touched, which is especially suitable for cleaning the anterior teeth and the flat tooth surface. By controlling motion amplitude and frequency of the x-y axis, the food residues between teeth can be effectively removed without hurting the gingiva.

The circumferential-axial composite motions combine a rotary motion around the axis of the brush head (circumferential motion) and a linear motion along the axis of the brush head (axial motion). For the posterior tooth region (molar region), because the complicated occlusal surface and more grooves, a more powerful and in-depth cleaning action is required. The personal care apparatus may switch to the circumferential-axial composite motions as the initial motion mode here, and use the rapid circumferential rotation combined with the high-frequency axial vibration to thoroughly clean the grooves and cracks on the occlusal surface. Slow circumferential rotation and gentle axial motion can help to polish the tooth surface, reduce the surface roughness and make the teeth smoother. Compared with the anterior tooth region, the initial motion mode of this region has significant differences in motion frequency, reciprocating angle and motion stroke.

The two circumferential composite motions are two independence but coordinated circumferential motions, which may relate to different rotation speeds, directions or angles. When the two circumferential composite motions relate to cleaning the vicinity of the gingiva line or the inner tooth surface, the personal care apparatus may be adjusted to two gentle circumferential composite motions as the initial motion mode. The two independent but coordinated circumferential motions may relate to different rotation speeds, directions or angles. For example, one rapid circumferential rotation is used to clean a large area, while the other slower and finer circumferential motion focuses on detailed parts, such as edges of teeth and the vicinity of the gingiva line. Such setting simulates a hand massage effect, promotes blood circulation of the gingiva and enhances health of the gingiva. The initial motion mode used here is mainly reflected in different reciprocating angles and different motion strokes, so as to ensure that a good cleaning effect can be achieved without irritating sensitive gingiva.

By adopting the multi-mode motion, the personal care apparatus may provide highly customized cleaning experience according to different regions and characteristics of the oral cavity of the user.

In one embodiment of the present disclosure, the cleaning part includes at least two cleaning units, and the target motion includes motions of the at least two cleaning units. The personal care apparatus further includes a transmission mechanism attached to the driving unit. The transmission mechanism is in transmission connection with the cleaning unit and is configured to convert the initial motion output by the driving unit to at least one cleaning unit and drive the at least two cleaning units to move in two different motion modes respectively.

The cleaning part is used to clean the tooth surface. The cleaning part includes the at least two cleaning units, and the at least two cleaning units may be equipped with different types of bristles to meet the cleaning requirements of different cleaning regions. Shapes of the at least two cleaning units may be the same or different, for example, the cleaning unit a main cleaning action of which is vibration may be set as a rectangle, and the cleaning unit with a main cleaning action of which is rotation may be set as a circle, and the like.

The driving unit is a power source of the whole system and is responsible for outputting the initial motion. According to specific design requirements, the driving source may be an acoustic motor (outputting reciprocating vibration), a bidirectional motor (capable of vibrating in a reciprocating way and/or telescoping) or a servo motor (capable of rotating by 360 degrees). The transmission mechanism is attached to the driving unit. The transmission mechanism converts the initial motion output by the driving unit into the target motion and transfers the target motion to each cleaning unit, so as to drive the at least two cleaning units to move in two different motion modes respectively. The initial motion modes corresponding to different cleaning regions may be the same or may be different.

For example, when one driving source is used, one motor is required to be matched with multiple transmission structures at the same time because the target motions needs to be transmitted to multiple cleaning units at the same time. Therefore, it may be ensured that each cleaning unit can execute a specific motion mode by manually pressing a key to switch the transmission structure, or by adopting a mode of electronically controlling and automatically switching the transmission structure. One cleaning unit may execute axial vibration or x-y axis composite motions for large-area coverage and flat surface cleaning. The other cleaning unit performs circumferential rotation or two circumferential composite motions, focusing on fine cleaning of the occlusal surface or the vicinity of the gingiva line. If the system is equipped with multiple motors, each motor may correspond to each cleaning unit, thus simplifying the transmission structure and improving the efficiency.

For people with various tooth shapes and positions, especially those users with complicated restorations (such as crowns, bridges) or braces, the personal care apparatus of the present disclosure may provide more comprehensive and meticulous cleaning. The personal care apparatus may dynamically adjust a working mode of each cleaning unit according to an oral map and personal habits of the user to achieve highly customized cleaning effect. Whether one driving source or multiple driving sources are designed, it is intended to ensure that all the cleaning units can be effectively adapted to the needs of different oral regions, providing best cleaning experience.

In one embodiment of the present disclosure, the at least two cleaning units include a first cleaning unit and a second cleaning unit, and corresponding motions of the first cleaning unit in different cleaning regions have different motion modes; and/or, corresponding motions of the second cleaning unit in different cleaning regions have different motion modes.

Specifically, the at least two cleaning units may include the first cleaning unit and the second cleaning unit, and the motion modes of the first cleaning unit and the second cleaning unit may be different when performing motions in different cleaning regions.

For example, the first cleaning unit can execute different motion modes in different cleaning regions to ensure the best cleaning effect. For the anterior tooth region (incisor region), gentle x-y axis composite motions or circumferential rotation may be used to cover a large and flat tooth surface and gently remove the dental plaque. For the posterior tooth region (molar tooth), circumferential-axial composite motions with larger intensity are switched to thoroughly clean the complicated occlusal surface and the grooves by the combination of rotation and vibration. At the vicinity of the gingiva line, the motion intensity will be reduced and the motion mode will be optimized, for example, slight circumferential rotation combined with slow axial vibration will be adopted to protect sensitive gingival tissues.

The second cleaning unit may similarly execute different motion modes in different cleaning regions, or cooperate with the first cleaning unit to provide a more complicated and efficient cleaning mode. For example, the second cleaning unit may perform high-frequency axial vibration between the teeth to help remove the food residues embedded in the slits between teeth, which similar to an effect of using flossing. For the inner tooth surface, a combination of greater angle adjustment and moderate circular motion is adopted to ensure that every corner is cleaned. For the sides of teeth and the vicinity of the gingiva line, the second cleaning unit may adopt vertical vibration up and down or small-amplitude pulse action to avoid stimulating the gingiva and ensure thorough cleaning.

By combining the different motion modes of the first cleaning unit and the second cleaning unit, the personal care apparatus may dynamically adjust the working mode of each cleaning unit according to the oral structure and personal habits of the user, and realize highly customized cleaning effect. For example, in a comprehensive cleaning mode, when the user starts to brush teeth, the personal care apparatus will start the x-y axis composite motions of the first cleaning unit to cover a large area of tooth surface, and meanwhile, the second cleaning unit will perform high-frequency axial vibration to clean the slits between teeth. In a fine cleaning mode, when turning to the posterior teeth, the first cleaning unit switches to the circumferential-axial composite motions, while the second cleaning unit continues the high-frequency vibration to ensure that each region can be cleaned meticulously. In a gingiva care mode, for the sensitive region in the vicinity of the gingiva line, the two cleaning units may jointly adopt gentle circumferential rotation and axial vibration, which can not only ensure the cleaning effect, but also avoid unnecessary pressure on the gingiva.

By controlling the action of each cleaning unit, each tooth region is ensured to be cleaned most effectively and risks of dental plaque and tooth decay are reduced. The combination of multi-mode motion and multi-cleaning units provides a softer but more efficient cleaning process, reducing a potential damage to the gingiva and other soft tissues. Based on the specific oral conditions and usage habits of the user, the personal care apparatus may provide a custom-made cleaning solution to help the user develop good oral hygiene habits. In addition, by intelligently distributing power to different cleaning units, the personal care apparatus may save energy and prolong a battery life while ensuring the cleaning effect.

In one embodiment of the present disclosure, motion modes of the at least two cleaning units at least include one of the following differences: different motion paths, different motion frequencies, different reciprocating angles and different motion strokes.

In order to ensure that the two cleaning units of the personal care apparatus can provide efficient cleaning effect in different cleaning regions, the motion mode of each cleaning unit includes at least one of the following differences: different motion paths, different motion frequencies, different reciprocating angles and different motion strokes. The following is a concrete explanation of how to realize personalized and efficient cleaning through the combination of these differences.

The different motion paths mean that the cleaning unit takes different paths when executing cleaning tasks. For example, the transmission mechanism converts the initial motion into the x-y axis composite motion or the circumferential rotation motion to the first cleaning unit, which is suitable for large-area coverage and flat surface cleaning, such as the anterior tooth region. This allows the brush head to move simultaneously or alternately in two directions perpendicular to each other, forming a complicated two-dimensional motion path to touch every corner of the tooth surface. The transmission mechanism drives the second cleaning unit to perform high-frequency axial vibration or a more complicated curved path, which is used for cleaning the food residues between teeth or cleaning the complicated occlusal surface of the posterior teeth.

The different motion frequencies mean different quantities of vibrations or rotation per unit time. For example, the first cleaning unit may adopt low-frequency motion in the sensitive region such as the vicinity of the gingiva line to reduce the irritation to the gingiva. The second cleaning unit may use high-frequency rapid vibration or rotation for regions that need more thorough cleaning, such as the molar region, to ensure deep cleaning.

The different reciprocating angles mean different maximum offset angles of the cleaning unit when reciprocating. For example, the first cleaning unit may only need a small angle change on the outer tooth surfaces because these surfaces are relatively flat. The second cleaning unit may need greater angle adjustment for irregular shapes in the inner tooth surface or the vicinity of the gingiva line to ensure that every corner is cleaned.

The different motion strokes mean different motion distances of the cleaning unit in the entire motion period. For example, the first cleaning unit may take a longer stroke for large and flat surfaces such as the anterior teeth to ensure that the whole surface is uniformly cleaned. The second cleaning unit may adopt short but frequent stroke to assist cleaning the slits between teeth or other narrow space by using a water flow or an air flow generated by high-frequency vibration.

By flexibly combining the different motion modes of the first cleaning unit and the second cleaning unit, the intelligent personal care apparatus can provide the user with more scientific, efficient and personalized cleaning experience. With the progress of related art, we can expect more innovative features to be introduced into such products in the future, and further improve an oral health management level of the user.

In one embodiment of the present disclosure, the motion path includes, but is not limited to: a pivot path, a reciprocating rotation path, a knocking motion path, a reciprocating vibration path, a reciprocating sweeping path, a horizontal linear motion, a longitudinal linear motion and/or a pendulum motion.

Specifically, the two cleaning units of the personal care apparatus may adopt a variety of complicated motion paths to optimize the cleaning effect of different tooth regions. These motion paths may include, but are not limited to: the pivot path, the reciprocating rotation path, the knocking motion path, the reciprocating vibration path, the reciprocating sweeping path, the horizontal linear motion, the longitudinal linear motion and/or the pendulum motion.

The pivot path refers to a rotation motion of the cleaning unit around one fixed point. For example, the anterior tooth region is suitable for large-area coverage and flat surface cleaning, which can ensure that each tooth surface is evenly cleaned, and the inner tooth surface helps to adapt to irregular shapes and ensure that every corner is cleaned.

The reciprocating rotation path refers to that the cleaning unit rotates back and forth within a certain angle range. For example, in the complicated structure of the posterior tooth region, especially the occlusal surface, this path helps remove the dental plaque in grooves and cracks, and gentle reciprocating rotation in the vicinity of the gingiva line can massage the gingiva and promote blood circulation.

The knocking motion path refers to that the cleaning unit moves up and down quickly at a certain frequency to simulate a knocking action. For example, high-frequency knocking action in the slits between teeth may help to remove the food residues embedded in the slits between teeth, similar to the effect of using flossing, and gentle knocking at roots of teeth helps to remove hard-to-reach places. The reciprocating rotation path refers to that the cleaning unit rotates back and forth quickly in a small scope. For example, slow reciprocating vibration may be used to gently polish the tooth surface and reduce the surface roughness, while high-frequency vibration may thoroughly clean the stains on the tooth surface and in the vicinity of the gingiva line.

The reciprocating sweeping path refers to that the cleaning unit moves back and forth in a certain direction to form a sweeping effect. For example, the anterior tooth region needs transverse or longitudinal reciprocating sweeping, which may help to clean the tooth surface thoroughly, especially for large flat regions. Slight reciprocating sweeping is required in the vicinity of the gingiva line, which may protect the gingiva while cleaning.

The horizontal linear motion means that the cleaning unit moves linearly in a horizontal direction. For example, the anterior tooth region is suitable for covering a large and flat tooth surface to ensure that each region can be cleaned evenly. The longitudinal linear motion means that the cleaning unit moves linearly in a vertical direction. For example, on the sides of teeth and the vicinity of the gingiva line, longitudinal linear motion may clean the sides of teeth and avoid irritating the gingiva.

The pendulum motion refers to that the cleaning unit swings back and forth like a pendulum, forming an arc-shaped path. For example, in the posterior tooth region, the pendulum motion may effectively cover the complicated occlusal surface, ensuring that the grooves and the cracks can be cleaned. In the vicinity of the gingiva line, the gentle pendulum motion can massage the gingiva while cleaning, so as to promote health.

By combining the plurality of motion paths mentioned above, the personal care apparatus can dynamically adjust the working mode of each cleaning unit according to the needs of different cleaning regions, providing highly customized cleaning experience. For example, in the overall cleaning mode, when the user starts to brush teeth, the first cleaning unit may cover the entire front anterior tooth surface with a pivot path, while the second cleaning unit performs high-frequency reciprocating vibration to clean the slits between teeth at the same time. In the fine cleaning mode, when turning to the posterior teeth, the first cleaning unit switches to the pendulum motion, while the second cleaning unit continues to perform the knocking motion to ensure that each region can be carefully cleaned. In the gingiva care mode, for the sensitive region such as the vicinity of the gingiva line, the two cleaning units may jointly adopt the reciprocating rotation path and gentle knocking motion, which can not only ensure the cleaning effect, but also avoid unnecessary pressure on the gingiva.

By flexibly combining the different motion paths of the plurality of cleaning units, the personal care apparatus can provide the user with more scientific, efficient and personalized cleaning experience.

In one embodiment of the present disclosure, the sensing unit includes an attitude sensor.

The personal care apparatus (such as a smart toothbrush) can monitor and analyze the brushing attitude of the user in real time to ensure that each cleaning action is accurately targeted at the target region. The attitude sensor can provide key information about brushing angle, direction, intensity and the like, and help the personal care apparatus to dynamically adjust a cleaning strategy, thus improving the cleaning efficiency and protecting the oral health.

Firstly, the attitude sensor may accurately measure an angle of the brush head relative to the teeth. For example, when the brush head forms an angle of about 45 degrees with the tooth surface, it usually means that the user is cleaning the anterior tooth region. When the brush head is close to the occlusal surface and the angle is large (for example, 60-90 degrees), it means that the user is cleaning the posterior tooth region. When the brush head has a small angle change (such as within 30 degrees), it may indicate that the user is cleaning the side teeth.

Secondly, by detecting a moving direction of the brush head, the personal care apparatus may judge whether the user covers all the tooth surfaces correctly. For example, the linear motion of the brush head in transverse or longitudinal direction is usually used to clean the anterior teeth region. Complicated curved path or pendulum motion is more common in the posterior teeth region. Slight reciprocating sweeping or slow circumferential rotation is used to clean the region in the vicinity of the gingiva line.

In addition, a three-dimensional position change of the brush head in the oral cavity may be tracked in combination with data of an accelerometer and a gyroscope. For example, when the brush head moves from one side to the other in a large range, it indicates that the user is cleaning the anterior tooth region. When the brush head goes deep into the oral cavity and moves in a small range, it indicates that the user is cleaning the posterior tooth region. When the brush head moves finely in a narrow space, it indicates that the user is cleaning the slits between teeth.

For example, when the user cleans the anterior tooth region, the attitude sensor detects that the brush head forms an angle of about 45 degrees with the tooth surface, and the brush head moves laterally or longitudinally in a large range in the oral cavity. The control unit determines that the target cleaning region is the anterior tooth region based on the current brushing attitude information, that is, the cleaning part may be driven to rotate alternately in two directions (rotation direction), keep a small rotation angle, and adopt moderate rotation speed and gentle torque to ensure comprehensive coverage and effective flat surface cleaning.

When the user turns to clean the posterior tooth region, the posture sensor detects that the brush head is close to the occlusal surface with a larger angle (60-90 degrees), and the brush head enters the deep part of the oral cavity and moves in a small range. According to the new brushing attitude information, the control unit switches the cleaning part to a larger rotation angle, improves the rotation speed and increases an appropriate torque to ensure the effective cleaning of the complicated occlusal surface.

In a word, the intelligent personal care apparatus not only improves the cleaning efficiency, but also enhances the user experience by comprehensively using the brushing attitude information provided by the attitude sensor, making the daily oral care more scientific and reasonable.

In one embodiment of the present disclosure, the sensing unit further includes a pressure sensor, and the sensing unit is further used to sense pressure information applied to the personal care apparatus and transmit the sensed pressure information to the control unit. The control unit is further used to determine the corresponding driving parameter according to the target cleaning region and the pressure information to generate the control signal.

In order to improve an accuracy of detecting the tooth region by the sensing unit, the sensing unit further includes the pressure sensor, which is used to sense the pressure information applied by the personal care apparatus and transmit the sensed pressure information to the control unit, and the control unit determines the corresponding driving parameter according to the target cleaning region and the pressure information to generate the control signal, which is specifically as follows.

When the attitude sensor detects that the brush head is close to an angle of 45 degrees and the pressure is moderate, the control unit confirms that the user is cleaning the anterior tooth region. When the attitude sensor detects that the brush head is close to the occlusal surface and the angle is large, and the pressure sensor shows that the pressure is moderate at the same time, the control unit confirms that the user is cleaning the posterior tooth region. When the attitude sensor detects a smaller angle change and the pressure sensor displays a gentle pressure, the control unit confirms that the user is cleaning the side tooth surface. When the attitude sensor detects a small angle change and the pressure sensor displays a very gentle pressure, the control unit confirms that the user is cleaning the vicinity of the gingiva line. When the attitude sensor detects a very small angle change and the pressure sensor displays a moderate pressure, the control unit confirms that the user is cleaning the slits between teeth.

A specific workflow of the control unit is as follows: the control unit receives real-time information from the attitude sensor and the pressure sensor to know the current brushing attitude and the applied pressure; determines the specific tooth region that the user is currently cleaning according to the angle, the direction, the position change and the pressure information of the brush head; selects the driving parameter includes selecting the most suitable rotation direction according to the requirements of the target cleaning region; sets an appropriate rotation angle to adapt to different shapes of tooth surfaces; adjusts the rotation speed to ensure the best cleaning effect according to the characteristics of the cleaning region; and adjusts the torque to avoid excessive force or insufficient cleaning according to the pressure information. The control unit converts the selected driving parameter into the specific control signal and transmits the signal to the driving unit. During the whole brushing process, the control unit continuously monitors the sensed data and dynamically adjusts the driving parameter as needed to ensure the best cleaning effect and user experience.

When the user is cleaning the anterior tooth region, the attitude sensor detects that the brush head forms an angle of about 45 degrees with the tooth surface, and the pressure sensor displays that the pressure is moderate. The control unit determines that the current cleaning region is the anterior tooth region based on the current brushing attitude information, and drives the cleaning part to rotate alternately in two directions (rotation direction), keep a small rotation angle, and adopt moderate rotation speed and gentle torque to ensure comprehensive coverage and effective flat surface cleaning.

When the user turns to the posterior tooth region, the attitude sensor detects that the brush head is close to the occlusal surface with a large angle (60-90 degrees), and the pressure sensor displays that the pressure is moderate. According to the new attitude and pressure information, the control unit determines that the current cleaning region is the posterior tooth region, switches the first cleaning unit to a larger rotation angle, improves the rotation speed and increases an appropriate torque to ensure the effective cleaning of the complicated occlusal surface. If the pressure applied by the user is too large, the control unit will give an alarm to remind the user and temporarily reduce the rotation speed and the torque until the pressure returns to normal.

In one embodiment of the present disclosure, the control unit determines the driving parameter based on the target cleaning region, wherein the driving parameter includes, but is not limited to: a rotation direction, a rotation angle, a rotation speed and/or a torque.

In order to ensure that the personal care apparatus provides the most efficient cleaning effect in different cleaning regions, the control unit determines the driving parameter based on the target cleaning region. The driving parameter includes, but is not limited to, the rotation direction, the rotation angle, the rotation speed and/or the torque. In addition, the personal care apparatus also regulates the rotation speed and a pendulum deflection of a vibration element through a duty ratio to achieve more accurate control. Corresponding to feedback to the brush head, a rotation direction of the motor determines a vibration direction and a rotation direction of a cleaning element in the brush head, a central angle of the motor rotation determines amplitude or central rotation angle of the cleaning element in the brush head, the rotation speed determines the vibration or rotation frequency of the cleaning element in the brush head, and the torque determines a cleaning strength of the cleaning element in the brush head.

The rotation direction refers to a rotation direction of the cleaning unit, which may be clockwise or counterclockwise. For the anterior tooth region, two-way alternating rotation direction may be used to ensure the coverage of the entire tooth surface and avoid excessive pressure in one direction. For the complicated occlusal surface of the posterior tooth region, a specific rotation direction may be selected to better adapt to the grooves and the cracks. The rotation direction of the motor directly affects the vibration or rotation direction of the cleaning element in the brush head, thus optimizing the cleaning effect on different regions.

The rotation angle refers to a maximum offset angle of the cleaning unit in a single rotation. For the outer tooth surfaces, a small rotation angle is usually required because these surfaces are relatively flat and have a large contact area. For the inner tooth surface and the vicinity of the gingiva line, a larger rotation angle is required to better adapt to the irregular shapes and clean every corner. A central rotation angle of the motor determines the amplitude or the central rotation angle of the cleaning element in the brush head, which enables the transmission mechanism to accurately adjust a motion range of each cleaning unit to meet the needs of different oral regions.

The rotation speed refers to a quantity of rotations per unit time. For the sensitive regions, such as the vicinity of the gingiva line, a lower rotation speed may be used to reduce the irritation to the gingiva. For the posterior tooth region, a higher rotation speed may be used due to the need to remove the food residues and the dental plaque more thoroughly. The rotation speed determines a frequency of vibration or rotation of the cleaning element in the brush head. By adjusting the rotation speed of the motor, the control unit can flexibly adjust the cleaning efficiency to ensure gentle and effective cleaning.

The torque refers to the torque generated when the cleaning unit rotates. For the slits between teeth, high-frequency vibration combined with moderate torque can help remove the food residues embedded in the slits between teeth, which is similar to the effect of using flossing. For the tooth surface region with a large area, a light torque may be used to gently polish the tooth surface and reduce the surface roughness. The torque determines a cleaning strength of the cleaning element in the brush head, ensuring that appropriate pressure may be provided under different cleaning requirements.

When the user is cleaning the anterior tooth region, the attitude sensor detects that the brush head is contacted with the teeth by an angle of 45 degrees, and the pressure sensor displays that the pressure applied is moderate. The control unit determines that the current attitude and the current pressure are suitable for the region, and thus drives the cleaning part to rotate alternately in two directions (rotation direction), keep a small rotation angle, and adopt moderate rotation speed and gentle torque to ensure comprehensive coverage and effective flat surface cleaning. Meanwhile, the control unit can also fine-tune the rotation speed and the pendulum deflection of the vibration element by adjusting the duty ratio, further optimizing the cleaning experience.

When the user turns to the posterior tooth region, the attitude sensor detects that the angle of the brush head is changed, and the pressure sensor displays that the pressure is moderate. According to the new attitude and pressure information, the control unit switches the cleaning part to a larger rotation angle, improves the rotation speed and increases an appropriate torque to ensure the effective cleaning of the complicated occlusal surface. If the pressure applied by the user is too large, the control unit will give an alarm to remind the user and temporarily reduce the rotation speed and the torque until the pressure returns to normal. In this case, a duty ratio control mechanism also plays a key role, which allows the system to respond quickly and adjust to a safe and effective cleaning mode.

In a word, the intelligent personal care apparatus not only improves the cleaning efficiency, but also enhances the user experience by accurately adjusting the driving parameter such as the rotation direction, the rotation angle, the rotation speed and the torque. Based on the characteristics of the rotation direction, the central angle, the rotation speed and the torque of the motor, the control unit can dynamically adjust the cleaning mode, provide the user with a highly customized cleaning solution, ensure that each oral region can obtain the best cleaning effect, and protect the gingiva health.

In one embodiment of the present disclosure, the initial motion is a periodic motion, and at least partial motion modes of the periodic motions corresponding to the different cleaning regions are different.

The periodic motion means that the cleaning unit repeats the same motion mode according to certain rules. This motion mode may be simple reciprocating motion and rotation motion, or more complicated composite motions. The key point is that the motion parameters (such as the rotation direction, the rotation angle, the rotation speed and the torque) in each period may be adjusted according to the needs of the target cleaning region.

The periodic motion in the anterior tooth region is designed as gentle horizontal linear motion or circumferential rotation, and periodic characteristics of the periodic motion in the anterior tooth region include bidirectional alternating rotation to ensure comprehensive coverage, small angle change suitable for flat surfaces, moderate rotation speed which can effectively clean the gingiva without causing excessive pressure, and gentle torque to reduce the irritation to the vicinity of the gingiva line. This combination ensures a gentle and efficient cleaning effect of the anterior tooth region.

The periodic motion in the posterior tooth region adopts strong pendulum motion or circumferential-axial composite motions, and periodic characteristics of the periodic motion in the posterior tooth region include unidirectional or bidirectional rotation, which may be flexibly adjusted according to a complexity of the occlusal surface. Large rotation angle adapts to complicated grooves and cracks, high rotation speed ensures deep cleaning effect, and moderate torque can effectively remove the dental plaque without damaging enamel. This design ensures the thorough cleaning of the posterior tooth region.

The periodic motion in the vicinity of the gingiva line consists of slight circumferential rotation and slow axial vibration, and periodic characteristics of the periodic motion in the vicinity of the gingiva line include gentle unidirectional or bidirectional rotation to avoid excessive irritation to the gingiva. Small angle changes focus on fine cleaning around the gingiva line, low rotation speed protects sensitive gingiva tissues, and very gentle torque prevents unnecessary pressure on the gingiva, thus achieving gentle and effective cleaning.

The periodic motion in the slits between teeth mainly depends on high-frequency axial vibration or knocking motion, which may be accompanied by slight circumferential rotation. Minimal rotation angle focuses on cleaning a narrow space, and high-frequency vibration simulates the effect of the flossing to ensure the removal of the embedded food residues. Moderate torque provides enough power for deep cleaning while avoiding damage to the teeth and the gingiva. This design ensures meticulous cleaning of the slits between teeth.

In one embodiment of the present disclosure, the periodic motion includes one or more motions with different modes, and the periodic motions corresponding to the different cleaning regions at least include one of the following differences: different motion quantities included, different output sequences of motions with the same mode and at least one different motion mode.

The periodic motion in the anterior tooth region includes two motion modes, which are a gentle horizontal linear motion and a slight circumferential rotation, and the two motion modes are included in each period, and are suitable for large-area coverage and flat surface cleaning. In contrast, the periodic motion in the posterior tooth region is more complicated, including three or more motion modes, which are an intense pendulum motion, circumferential-axial composite motions and high-frequency vibration, ensuring that the complicated occlusal surfaces and grooves are thoroughly cleaned.

The periodic motion in the vicinity of the gingiva line consists of slight circumferential rotation and slow axial vibration, and periodic characteristics of the periodic motion in the vicinity of the gingiva line are to rotate circumferentially to cover the gingiva line first, and then vibrate axially to massage the gingiva and protect the sensitive tissues. However, the periodic motion in the slits between teeth first carries out high-frequency vibration to remove the food residues, and then carries out knocking motion to ensure deep cleaning. The motion modes in the two regions are the same, but the output orders are different, which optimizes the cleaning effects of the respective regions.

The periodic motion in the outer tooth surface adopts moderate horizontal linear motion and gentle circumferential rotation, wherein the horizontal linear motion is used to cover a large area of surface and the circumferential rotation is used to clean edges finely. The periodic motion in the inner tooth surface uses a large rotation angle and a slight pendulum motion. The large rotation angle adapts to the irregular shapes, and the pendulum motion ensures that every corner is cleaned, which reflects that at least one motion mode in different regions is different to meet the respective cleaning needs.

The control unit first receives the real-time information from the attitude sensor and the pressure sensor to determine the specific tooth region that the user is currently cleaning. Then, according to the demand of the target cleaning region, the best quantity of motions, modes and output orders thereof are selected to ensure that the motion modes in each period conform to the best cleaning strategy of the region. Finally, the control unit generates a specific control signal and transmits the signal to the driving unit, and continuously monitors the sensed data during the whole brushing process, and dynamically adjusts the driving parameter to ensure the best cleaning effect and user experience.

According to a second aspect of the present disclosure, a computing apparatus is provided, including:

a memory and a processor, wherein:

the memory is used to store a computer-executable instruction, the processor is used to execute the computer-executable instruction, and the computer-executable instruction which, when being executed by the processor, implements the steps of the control method of the personal care apparatus mentioned above.

According to a third aspect of the present disclosure, a computer-readable storage medium storing a computer program is provided, wherein the computer-executable instruction, when being executed by a processor, implements the steps of the control method of the personal care apparatus mentioned above.

According to a fourth aspect of the present disclosure, a computer program product including a computer instruction is provided, wherein the computer program, when being executed by a processor, implements the steps of the control method of the personal care apparatus mentioned above.

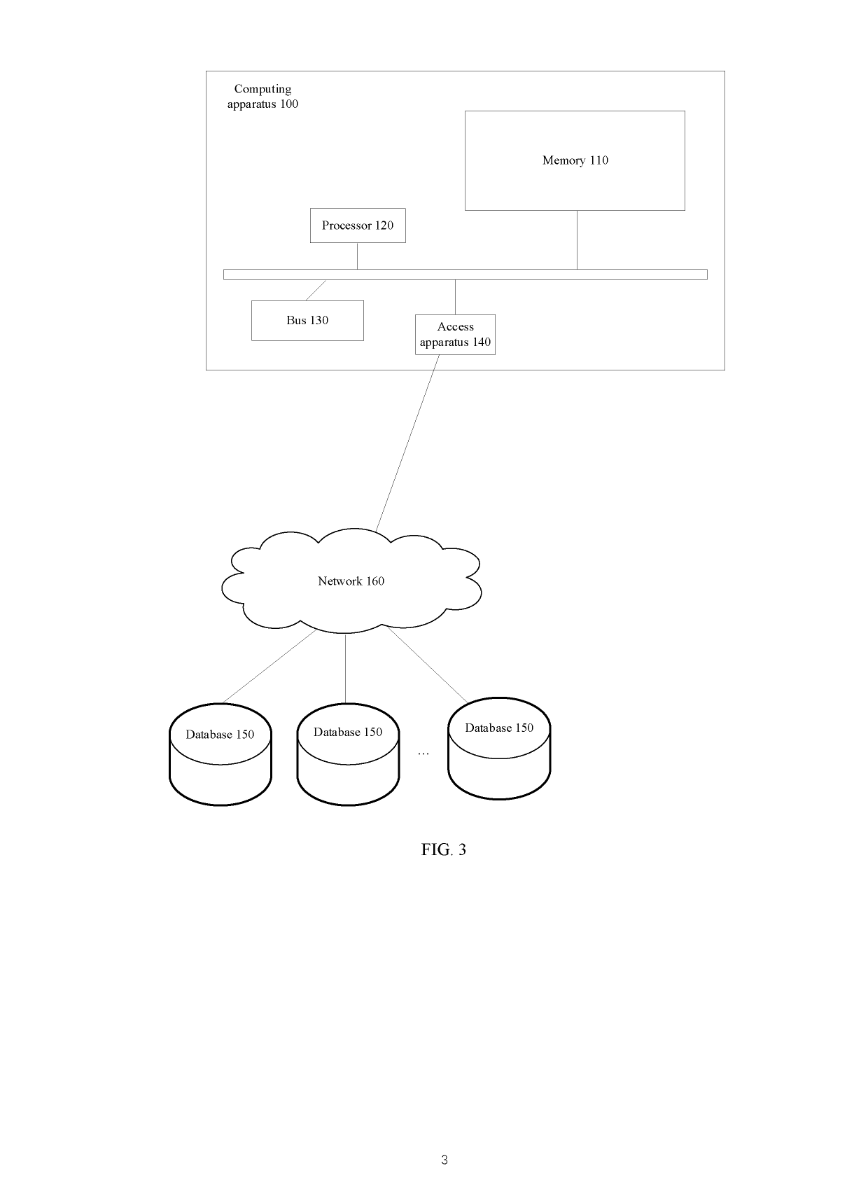

FIG. 3 illustrates a structural block diagram of a computing apparatus 100 provided by one embodiment of the present disclosure. Components of the computing apparatus 100 include, but are not limited to a memory 110 and a processor 120. The processor 120 is connected with the memory 110 through a bus 130, and a database 150 is used to store data.

The computing apparatus 100 further includes an access apparatus 140. The access apparatus 140 enables the computing apparatus 100 to communicate via one or more networks 160. Examples of these networks include a Public Switched Telephone Network (PSTN, Public Switched Telephone Network), a Local Area Network (LAN, Local Area Network), a Wide Area Network (WAN, Wide Area Network), a Personal Area Network (PAN, Personal Area Network) or a combination of communication networks such as the Internet. The access apparatus 140 may include one or more of any type of wired or wireless network interfaces (for example, a network interface controller (NIC, network interface controller)), such as an IEEE802.11 Wireless Local Area Network (WLAN, Wireless Local Area Network) wireless interface, a Worldwide Interoperability for Microwave Access (Wi-MAX, Worldwide Interoperability for Microwave Access) interface, an Ethernet interface, a Universal Serial Bus (USB, Universal Serial Bus) interface, a cellular network interface, a Bluetooth interface, and Near Field Communication (NFC, Near Field Communication).

In one embodiment of the present disclosure, the above components of the computing apparatus 100 and other components not shown in FIG. 3 may also be connected to each other, for example, through a bus. It should be understood that the structural block diagram of the computing apparatus shown in FIG. 3 is only for the purpose of example, and is not a limitation on the scope of the present disclosure. Those skilled in the art may add or replace other components as needed.

The computing apparatus 100 may be any type of static or mobile computing apparatus, including a mobile computer or a mobile computing apparatus (for example, a tablet computer, a personal digital assistant, a laptop computer, a notebook computer, a netbook, or the like), a mobile phone (for example, a smart phone), a wearable computing apparatus (for example, a smart watch, smart glasses, or the like) or other types of mobile device, or a static computing apparatus such as a desktop computer or a Personal Computer (PC, Personal Computer). The computing apparatus 100 may also be a mobile or static server.

The processor 120 is used to execute a following computer-executable instruction, and the computer-executable instruction which, when being executed by the processor, implements the steps of the control method of the personal care apparatus mentioned above.

The above is a schematic solution of the computing apparatus according to the embodiment. It should be noted that the technical solution of the computing apparatus belongs to the same concept as the technical solution of the control method of the personal care apparatus mentioned above, and details not described in detail in the technical solution of the computing apparatus may be referred to the description of the technical solution of the control method of the personal care apparatus mentioned above.

One embodiment of the present disclosure further provides a computer-readable storage medium storing a computer-executable instruction thereon, wherein the computer-executable instruction, when being executed by a processor, implements the steps of the control method of the personal care apparatus mentioned above.

The above is a schematic solution of the computer-readable storage medium according to the embodiment. It should be noted that the technical solution of the storage medium belongs to the same concept as the technical solution of the control method of the personal care apparatus mentioned above, and details not described in detail in the technical solution of the storage medium may be referred to the description of the technical solution of the control method of the personal care apparatus mentioned above.

One embodiment of the present disclosure further provides a computer program product, wherein the computer program product, when being executed in a computer, enables the computer to execute the steps of the control method of the personal care apparatus mentioned above.

The above is a schematic solution of the computer program product according to the embodiment. It should be noted that the technical solution of the computer program product belongs to the same concept as the technical solution of the control method of the personal care apparatus mentioned above, and details not described in detail in the technical solution of the computer program product may be referred to the description of the technical solution of the control method of the personal care apparatus mentioned above.

Specific embodiments of the present disclosure have been described above. Other embodiments are within the scope of the appended claims. In some cases, the actions or steps recited in the claims may be performed in a different order than in the embodiments and still achieve the desired results. In addition, the processes depicted in the drawings do not necessarily require showing a specific order or a sequential order to achieve the desired results. In some embodiments, multitasking processing and parallel processing are also possible or may be advantageous.

The computer instruction includes a computer program code, which may be in the form of a source code, an object code, an executable file or some intermediate form. The computer-readable medium may include any entity or device, recording medium, USB disk, mobile hard disk, magnetic disk, optical disk, computer memory, Read Only Memory (ROM, Read-Only Memory), Random Access Memory, (RAM, Random Access Memory), electrical carrier signal, telecommunication signal and software distribution medium capable of carrying the computer program code. It should be noted that the contents contained in the computer-readable medium may be appropriately increased or decreased according to the requirements of patent practice. For example, in some areas, according to patent practice, the computer-readable medium does not include electrical carrier signals and telecommunication signals.

It should be noted that, for the sake of simple description, the fore-mentioned method embodiments are all expressed as a series of action combinations, but those skilled in the art should understand that the present disclosure is not limited by the described action sequences, because certain steps may be performed in other sequences or concurrently according to the embodiments of the present disclosure. Secondly, those skilled in the art should also understand that all the embodiments described in the specification are preferred embodiments, and the actions and modules involved are not necessarily required by the embodiments of the present disclosure.

In the foregoing embodiments, the descriptions of the embodiments have respective emphasis, and for parts that are not described in detail in a certain embodiment, reference may be made to the related descriptions of other embodiments.

The preferred embodiments of the present disclosure disclosed above are intended only to aid in the explanation of the present disclosure. Alternative embodiments are not exhaustive and do not limit the present disclosure to the specific embodiments described. Obviously, many modifications and variations are possible in light of the present disclosure. The embodiments are chosen and described in order to best explain the principles and the practical application of the present disclosure, to thereby enable others skilled in the art to best understand and make use of the present disclosure. The present disclosure is limited only by the claims and their full scope and equivalents.

What is claimed is:

1. A control method of a personal care apparatus, wherein the personal care apparatus comprises:
a cleaning part; and
a holding part comprising a driving unit, a control unit and a sensing unit accommodated in the holding part, wherein,
the sensing unit is electrically connected with the control unit and transmits sensed brushing attitude information to the control unit;
the control unit is configured to determine a target cleaning region based on the brushing attitude information, and determine a corresponding driving parameter according to the target cleaning region to generate a control signal; and
the driving unit is coupled with the cleaning part and configured to output an initial motion corresponding to the target cleaning region in response to one or more control signals sent by the control unit, and drive the cleaning part to execute a target motion corresponding to the target cleaning region, wherein at least partial motion modes of the target motions corresponding to different cleaning regions are different.

2. The control method of the personal care apparatus according to claim 1, wherein,
at least partial motion modes of the initial motions corresponding to different cleaning regions are different.

3. The control method of the personal care apparatus according to claim 1, wherein,
the motion modes of the initial motions corresponding to different cleaning regions at least comprise one of the following differences: different motion paths, different motion frequencies, different reciprocating angles and different motion strokes.

4. The control method of the personal care apparatus according to claim 3, wherein,
the initial motion path comprises, but is not limited to one or a combination of more of an axial motion and a circumferential motion.

5. The control method of the personal care apparatus according to claim 1, wherein,
the initial motion is a multi-mode motion, comprising but not limited to: x-y axis composite motions, circumferential-axial composite motions and two circumferential composite motions.

6. The control method of the personal care apparatus according to claim 1, wherein the cleaning part comprises at least two cleaning units, and the target motion comprises motions of the at least two cleaning units; and
the personal care apparatus further comprises a transmission mechanism attached to the driving unit, the transmission mechanism is in transmission connection with the cleaning unit and is configured to convert the initial motion output by the driving unit to at least one cleaning unit and drive the at least two cleaning units to move in two different motion modes respectively.

7. The control method of the personal care apparatus according to claim 6, wherein,
the at least two cleaning units comprise a first cleaning unit and a second cleaning unit,
corresponding motions of the first cleaning unit in different cleaning regions have different motion modes; and/or,
corresponding motions of the second cleaning unit in different cleaning regions have different motion modes.

8. The control method of the personal care apparatus according to claim 6, wherein motion modes of the at least two cleaning units at least comprise one of the following differences: different motion paths, different motion frequencies, different reciprocating angles and different motion strokes.

9. The control method of the personal care apparatus according to claim 8, wherein the motion path comprises, but is not limited to: a pivot path, a reciprocating rotation path, a knocking motion path, a reciprocating vibration path, a reciprocating sweeping path, a horizontal linear motion, a longitudinal linear motion and/or a pendulum motion.

10. The control method of the personal care apparatus according to claim 1, wherein the sensing unit comprises an attitude sensor.

11. The control method of the personal care apparatus according to claim 10, wherein the sensing unit further comprises a pressure sensor, and the sensing unit is further used to sense pressure information applied to the personal care apparatus and transmit the sensed pressure information to the control unit; and
the control unit is further used to determine the corresponding driving parameter according to the target cleaning region and the pressure information to generate the control signal.

12. The control method of the personal care apparatus according to claim 1, wherein the control unit determines the driving parameter based on the target cleaning region, wherein the driving parameter comprises, but is not limited to: a rotation direction, a rotation angle, a rotation speed and/or a torque.

13. The control method of the personal care apparatus according to claim 1, wherein the initial motion is a periodic motion, and at least partial motion modes of the periodic motions corresponding to the different cleaning regions are different.

14. The control method of the personal care apparatus according to claim 1, wherein the periodic motion comprises one or more motions with different modes, and the periodic motions corresponding to the different cleaning regions at least comprise one of the following differences: different motion quantities comprised, different output sequences of motions with the same mode, and at least one different motion mode.

15. A computing apparatus, comprising:
a memory and a processor, wherein,
the memory is used to store a computer-executable instruction, and the processor is used to execute the computer-executable instruction, which, when being executed by the processor, implements the steps of the control method of the personal care apparatus according to claim 1.

16. A computer-readable storage medium storing a computer-executable instruction thereon, wherein the computer-executable instruction, when being executed by a processor, implements the steps of the control method of the personal care apparatus according to claim 1.
